(19) United States
(12) Patent Application Publication
(10) Pub. No.: US 2007/0162695 A1
(43) Pub. Date: Jul. 12, 2007

(54) Method for configuring a storage drive

(75) Inventors: Ahmad A. J. Ali, Austin, TX (US); Mark Lindholm, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/330,583

(22) Filed: Jan. 12, 2006

(51) Int. Cl. G06F 12/16

(52) U.S. Cl. 711/114

(57) ABSTRACT

A system and method is disclosed for configuring a storage drive. A Serial ATA drive is configured to include a self-describing RAID header. The self-describing RAID header identifies the storage drive as comprising a single volume of a RAID Level 0 array. Within the header, the size of the storage volume is identified and this size is used to limit the addressable space of the user content portion of the Serial ATA storage drive, thereby preventing the content of the standalone user content of the Serial ATA storage drive, which is not RAID complaint, from overlapping with the content of the self-describing RAID header.

### TECHNICAL FIELD

The present disclosure relates generally to computer systems and information handling systems, and, more particularly, to a method for configuring a storage drive.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may comprise one or more storage drives. Before a storage drive is put into use, the storage drive must be configured or formatted. Once a storage drive is configured for use as a standalone drive in non-RAID environment, it is difficult to reconfigure the drive for use in RAID environment while keeping the data in place during the reconfiguration process. With respect to Serial ATA (SATA) drives in non-RAID environment, it is often the case that the entire set of addressable space on the drive is consumed with user data, leaving little, if any, room for configuration data. Because a SATA drive cannot easily be reconfigured, it is difficult to migrate a SATA drive from a storage environment that is not RAID-compliant to a RAID storage environment.

### SUMMARY

In accordance with the present disclosure, a system and method is disclosed for configuring a Serial ATA (SATA) storage drive to allow the migration of a standalone SATA drive from non-RAID system to a RAID environment. A Serial ATA drive is configured to include a self-describing RAID header. The self-describing RAID header identifies the storage volume as comprising a single volume of a RAID Level 0 array. Within the header, the size of volume is identified and this size is used to identify and limit the user-addressable space of the Serial ATA disk, thereby preventing the user-accessible space of the Serial ATA disk in non-RAID environment from overlapping with the content of the self-describing RAID header. In RAID-compliant environments, the disk would be recognized, and the user data would be accessible.

The method disclosed herein is technically advantageous because it permits a Serial ATA drive to be nested within a RAID Level 0 storage volume. Because of this configuration, the storage volume can be used as a Serial ATA drive in a non-RAID environment and can also be easily migrated to a RAID environment. The inclusion of the self-describing RAID header within the storage drive allows the drive to be reconfigured as a RAID volume without the necessity of removing or redistributing the content of the storage volume.

Another technical advantage of the method disclosed herein is that the content of the user data portion of the SATA drive does not conflict or overlap with the content of the self-describing RAID header. The size of the volume is used as a parameter during a configuration step to limit the addressable space of the user data portion of the Serial ATA storage volume. As a result, the user data portion of the storage volume does not overlap or overwrite the self-describing RAID array. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a storage drive;

FIG. 2 is an expanded view of the self-describing RAID header of the storage drive; and

FIG. 3 is a flow diagram of a method for configuring a Serial ATA drive to accommodate a self-describing RAID header.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

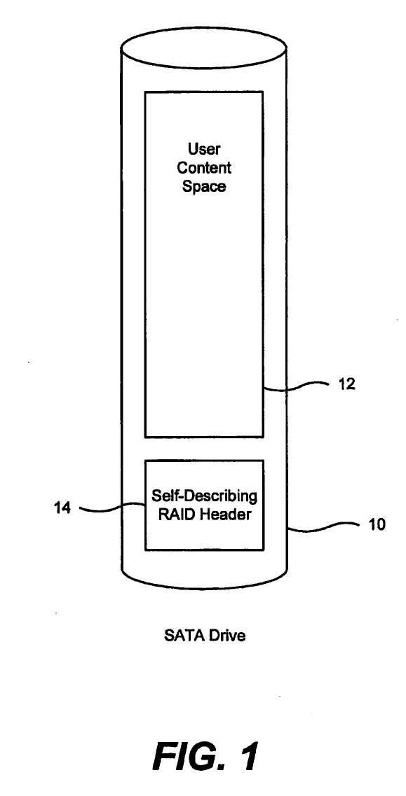

An information handling system may include one or more storage drives. Shown in FIG. 1 is a diagram of a storage drive 10. Storage drive 10 is configured as a RAID Level 0 storage drive. In a RAID volume, a RAID Level 0 configuration involves the striping of data across the storage devices. RAID Level 0 does not involve a parity calculation, redundancy, or fault tolerance. In the case of single-drive RAID Level 0 configuration, as shown in FIG. 1, the issues of parity, redundancy, and fault tolerance are not relevant, as the entire content of the RAID volume exists in a single drive. Storage drive 10 includes user content space 12 and a self-describing RAID header 14. The user content space 12 includes all of the addressable space that is typically user-accessible and comprises a self-contained SATA drive in non-RAID environment.

Self-describing RAID header 14 is a header that provides identification and configuration information for the drive 10 and the RAID array (which in this case comprises a single volume). The use of self-describing RAID headers in a RAID array is described in U.S. application Ser. No. 11/036,679, which is titled “System and Method for Implementing Self-Describing RAID Configurations,” and which is incorporated herein by reference. An example of a protocol for a self-describing RAID header is the Common RAID Disk Data Format of the Storage Networking Industry Association (SNIA). A self-describing RAID header includes configuration information that describes the format of the data in the volume and across the disks of the RAID array.

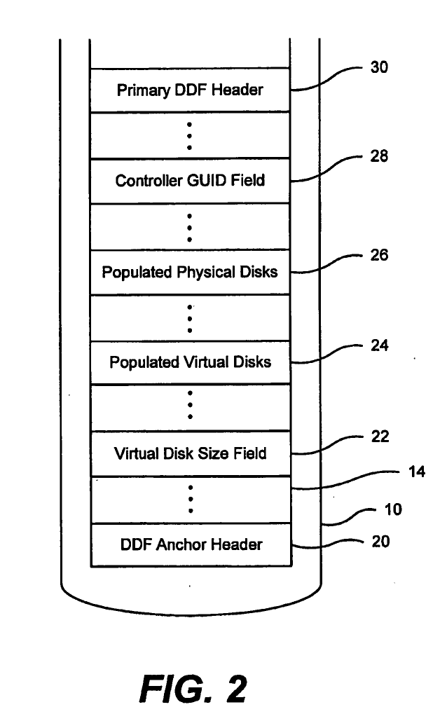

Shown in FIG. 2 is an expanded view of the self-describing RAID header 14 within the storage drive 10. A self-describing RAID header will include a number of fields that are populated with configuration information for the drive and the entire RAID array. A DDF anchor header 20 is stored at the end of the physical disk and occupies the last addressable block on the physical disk. DDF anchor header 20 includes a pointer to the primary DDF header 30, which includes the primary configuration data for the self-describing header. Thus, the anchor DDF header identifies the end of the self-describing header and points to the first entry in the primary section of the self-describing header. DDF anchor header 20 also includes an identifier, tag, or signature that identifies the DDF anchor header as being a valid DDF anchor header. In this manner, the DDF anchor header identifies the self-describing header as a valid self-describing header for a RAID drive. As such, the presence of a valid DDF anchor header identifies the drive as comprising a RAID drive.

The controller globally unique identifier (GUID) field 28 includes a unique identifier for the storage controller that performed the configuration of storage drive 10. The unique identifier in the controller GUID field 28 will indicate, for example, if the storage drive was configured by a controller that is able to configure a SATA drive according to the configuration model of FIG. 1, which is characterized by the inclusion of a self-describing RAID header with the content of the SATA storage drive. Thus, the controller GUID will include a marker that identifies whether the storage drive was configured by a controller that is programmed to format a storage drive according to the configuration of FIG. 1, including the configuration of a self-describing RAID header together with SATA content.

The populated physical disks field 26 indicates how many physical disks are present in the RAID array, and the populated virtual disk field 24 indicates how many virtual disks are present in the RAID array. The number of virtual disks is the number of logical disks as seen by the storage controller or storage controllers of the RAID array. A set of physical disks may include one or more virtual disks. The virtual disk size field indicates the size or length in bytes of the virtual disk of the RAID array. If multiple virtual disks are included in the RAID volume a size field will be associated with each virtual disk. In this example, assuming that only a single virtual disk is included in storage drive 10, the disk size field indicates the number of bytes in the self-describing RAID header.

The self-describing RAID header could be established and populated by any device that is able to write to a storage location of the storage volume during an initialization routine. This device could be a storage controller or some other computing device. The configuration process involves writing a signature to the DDF anchor header that identifies the storage volume as comprising as being a RAID volume. A pointer to the primary DDF header will also be included in the DDF anchor header. The controller GUID will be populated with a unique identifier for a storage controller that is able to configure and recognize a storage volume that includes user content space nested within a RAID Level 0 volume. The number “1” is written to both the populated physical disks field and the populated virtual disks field. The size of the user content space is written to the virtual disk size field. The process of formatting the self-describing RAID header 14 is typically done before the formatting of the user content space of the SATA drive. Once the self-describing RAID header is written to the drive, the drive can be recognized RAID controllers as a SATA drive that is configured as a single disk RAID Level 0 volume.

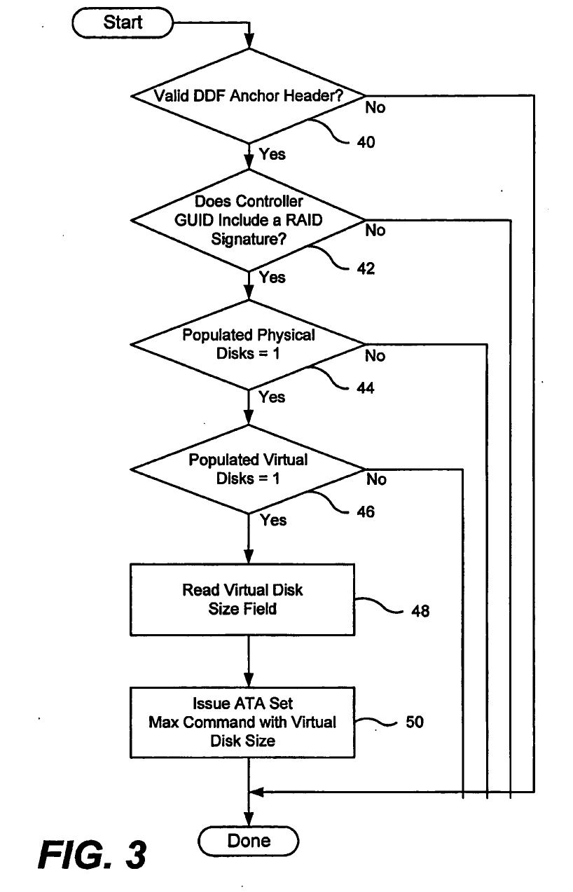

Shown in FIG. 3 is a flow diagram of a series of method steps for determining whether a storage drive includes a self-describing RAID header for the purpose of configuring the user content portion of the storage volume so as not to interfere or overlap with the self-describing RAID header. The steps of FIG. 3 are performed by a storage controller or other device that is involved in configuring the storage drive in non-RAID environment. At step 40, the storage controller determines if the drive includes a valid DDF anchor header. The storage controller looks to the last addressable location on the drive and determines if this location includes a pointer address to the primary DDF header and a signature identifying the DDF anchor header as the anchor header for a self-describing RAID array. If the anchor header is not a valid anchor header, the configuration process ends and the SATA drive need not be configured to accommodate a self-describing RAID configuration. If the DDF anchor header is valid, it is next determined at step 42 if the controller GUID field includes a valid signature for a storage controller or other configuring device that is able to configure a storage drive to include a self-describing RAID header. If the controller GUID field has a valid signature, the verification and configuration steps of the method continue. If the controller GUID field does not have a valid signature, the configuration method terminates.

If the controller GUID field includes a valid controller identifier, it is next determined at step 44 if the content of the populated physical disks field is 1, which indicates that the number of physical disks in the RAID array is 1. If yes, the method continues. If the number of populated physical disks is not 1, the configuration method terminates. Following step 44, it is determined at step 46 if the number of populated virtual disks is 1, which indicates that only a singe logical volume is included in the RAID array. If the number of populated virtual disks is 1, the configuration method continues; if not, the method terminates. At step 48, the controller reads the virtual disk size field, which identifies the size of the self-describing RAID header. At step 50, the controller issues a SATA Set Max command, which sets a maximum addressable space that redefines the capacity of the drive as excluding the number of bytes reserved for the self-describing RAID header. The number of bytes reserved for the self-describing RAID header is capacity of the SATA disk minus the value of the virtual disk size field. These bytes are excluded from being addressable by the SATA controller and the highest or last addressable byte of the SATA content of the drive is the byte preceding the self-describing RAID header. If the process terminates before step 48 then entire space on the SATA disk is available for user content as usual.

By following the method steps of FIG. 3, a SATA controller is able to determine if a storage drive includes a self-describing RAID header, and, if so, configure the user content portion of the disk to accommodate the self-describing RAID header. Once the storage drive is configured in this fashion, the storage drive has the format of a RAID Level 0 storage drive. Although the SATA disk can thereafter be used as a standalone SATA drive in a non-RAID environment, the format of the drive allows it to be easily migrated to a RAID environment with user data in place.

The configuration technique described herein involves the nesting of an SATA drive within a RAID Level 0 drive. The self-describing header of the RAID Level 0 does not interfere with the user content space of the SATA drive. In non-RAID environment the host operating system does not recognize that the drive also includes a self-describing RAID header that defines the drive as being a RAID Level 0 drive in a RAID-complaint environment. It should also be recognized that the RAID Level 0 drive of the present disclosure constitutes and is configured as a one-drive RAID array. Thus, even though the RAID array consists of only a single drive, the drive is nonetheless configured in RAID Level 0 configuration to constitute the lone drive of a one-drive RAID array.

It should be recognized that the configuration method described herein is not limited in its application to a RAID storage methodology. Rather, the configuration method described herein may be used with any redundant or non-redundant storage methodology that allows the use of a self-describing header that is able to identify the volume and define its role as a standalone drive in the storage methodology. Although the present disclosure has been described in detail, it should be understood that various changes, substitutions, and alterations can be made hereto without departing from the spirit and the scope of the invention as defined by the appended claims.

What is claimed is:

1. A method for configuring a storage volume, comprising:
writing a header to the storage volume, wherein the header identifies the storage volume as a single volume of a storage array having a first storage format; and
writing to the portion of the storage volume not comprising the header a set of content according to a second storage format, wherein the definition of the storage volume according to the first storage format does not interfere with the operation of the storage volume according to the second storage format.

2. The method for configuring a storage volume of claim 1, wherein the first storage format is RAID and the header is a self-describing RAID header.

3. The method for configuring a storage volume of claim 2, wherein the header identifies the storage volume as comprising as RAID Level 0 storage volume.

4. The method for configuring a storage volume of claim 3, wherein the header identifies the RAID Level 0 array as comprising a single physical disk.

5. The method for configuring a storage volume of claim 4, wherein the header identifies the RAID Level 0 array as comprising a single virtual disk that has the size described in the self-describing RAID header.

6. The method for configuring a storage volume of claim 1, wherein the second storage format is a standalone Serial ATA drive.

7. The method for configuring a storage volume of claim 6, wherein the user content space of the Serial ATA storage drive does not exceed a maximum address within the storage volume.

8. The method for configuring a storage volume of claim 5, wherein the second storage format is a standalone Serial ATA.

9. The method for configuring a storage volume of claim 8, wherein the user content space of the Serial ATA storage drive does not exceed a maximum address within the storage volume.

10. A storage volume, comprising:
a header portion, wherein the header portion identifies the header portion as a single volume of a storage array having a first data format; and
a content portion, wherein the content portion has a second storage format;
wherein the presence of the header does not interfere with the operation of the storage volume according to the second storage format, and wherein the addressable space of the content portion does not overlap with the addressable space of the header portion.

11. The storage volume of claim 10, wherein the first storage format is RAID and the header portion is a self-describing RAID header.

12. The storage volume of claim 11, wherein the header identifies the storage volume as comprising a RAID Level 0 storage volume.

13. The storage volume of claim 12, wherein the header identifies the RAID Level 0 array as comprising a single physical disk.

14. The storage volume of claim 12, wherein the header identifies the RAID Level 0 array as comprising a single virtual disk that has the size described in the self-describing RAID header.

15. The storage volume of claim 10, wherein the second storage format is a standalone Serial ATA storage.

16. A method for configuring a storage drive, comprising:
identifying a header within the storage drive;
determining whether the header identifies the storage drive as comprising a single volume of a storage array having a first storage format;
determining the size of the single volume;
writing content to the storage drive according to a second storage format, wherein the addressable space of the content having the second storage format does not overlap with the addressable space of the header.

17. The method for configuring a storage volume of claim 16, wherein the first storage format is RAID.

18. The method for configuring a storage volume of claim 16, wherein the second storage format is a standalone Serial ATA drive.

19. The method for configuring a storage volume of claim 16, wherein the size of the header identifies the maximum addressable space available for the content of the second storage format.

20. The method for configuring a storage volume of claim 16, wherein the step of determining whether the header identifies the storage drive as comprising a single volume of a storage array having a first storage format comprises the step of determining whether the header identifies the storage volume as the only volume of a RAID Level 0 array.
